(19) United States
(12) Patent Application Publication
(10) Pub. No.: US 2002/0167536 A1
(43) Pub. Date: Nov. 14, 2002

(54) Method, system and device for augmented reality

(75) Inventors: Armando S. Valdes, Orpington (GB); Graham G. Thomason, Red Hill (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/109,771

(22) Filed: Mar. 29, 2002

(30) Foreign Application Priority Data
Mar. 30, 2001 (GB) 0107952.4
May 29, 2001 (GB) 0113146.5

(51) Int. Cl. G09G 5/00

(52) U.S. Cl. 345/633

(57) ABSTRACT

A portable electronic device comprises augmented reality viewing apparatus for viewing a real scene and a superimposed computer generated overlay scene. In one embodiment the viewing apparatus comprises a display screen (2) and a semitransparent mirror (3). The semitransparent mirror (3) is pivotally mounted on the device and may be rotated between a position for viewing augmented reality and a position for viewing a displayed image alone. In another embodiment the real scene is viewed through a transparent display screen. When viewing augmented reality, the user aligns the overlay scene with the real scene by means of an alignment indicator (13,15, not shown in FIG. 5) in the overlay scene which corresponds to a predetermined element of the real scene. The device may be equipped with location determining means (50), the selection of a displayed image thereby being dependent on the location of the device, whether the images for display are stored locally in the device or transmitted by radio from a remote server. The device may also be equipped with an orientation sensor so that the selection of a displayed images is dependent on orientation of the device.

The present invention relates to a method, system and device for augmented reality for use in particularly, but not exclusively, portable radio communication applications.

Head-up displays overlay computer generated information over a real scene and enable a user to read the computer generated information without turning his eyes away from the real scene. For example, U.S. Pat. No. 6,091,376 discloses a mobile telephone equipment for use in an automobile for enabling information and telephone push buttons to be displayed in a superimposed relation to a front view outside of the front windshield of the automobile. Examples of the types of information displayed are a telephone number and a call duration, when a call is placed, and speed of travel and distance travelled, when no call is placed.

In augmented reality systems, computer generated images are overlaid on a real scene to enhance the real scene. Tracking systems are used to provide accurate alignment of the computer generated images with the real scene. For example, U.S. Pat. No. 6,064,749 discloses a tracking system using analysis of images of the real scene obtained from cameras.

The overlay of a computer generated image over a real scene is typically implemented using a half-silvered mirror through which the user views the real scene, and which reflects to the user a computer generated image projected onto the half silvered mirror by a display device.

An object of the present invention is to provide improvements in augmented reality systems and apparatus, and improvements in methods for use in augmented reality systems and apparatus.

According to the invention there is provided a method of preparing an overlay scene for display on an augmented reality viewing apparatus, characterised by generating an alignment indicator corresponding to a predetermined element of a real scene for inclusion in the overlay scene, the alignment indicator in use being aligned with the predetermined element of the real scene.

According to another aspect of the invention there is provided an overlay scene suitable for combining with a real scene to form an augmented reality scene, comprising an alignment indicator corresponding to a predetermined element of the real scene, the alignment indicator in use being aligned with the predetermined element of the real scene.

The alignment indicator enables the overlay scene and real scene to be aligned by the user in a simple and low cost manner without requiring apparatus for analysing an image of the real scene and adapting the overlay image to the analysed image. The alignment indicator is chosen such that the user can readily recognise which element of the real scene the alignment indicator should be aligned with. For example, the alignment indicator may comprise a prominent shape. The alignment indicator may optionally include text to assist the user to perform the alignment.

According to another aspect of the invention there is provided a portable electronic device equipped with augmented reality viewing apparatus suitable for viewing a real scene and an overlay scene having an alignment indicator corresponding to a predetermined element of the real scene, the augmented reality viewing apparatus comprising a display screen, wherein the device has a first mode wherein the display screen displays an overlay scene and a second mode wherein the display screen displays a non-overlay scene.

By means of such a portable electronic device the user can view the augmented reality scene and can readily align the overlay scene with the real scene by means of an alignment indicator in the overlay scene. Furthermore, by means of such a portable electronic device the user can readily change from viewing only the display screen, to viewing an augmented reality scene, and vice versa.

In one embodiment the augmented viewing apparatus comprises a pivotally mounted semitransparent mirror arrangeable in a first position in which a user can view superimposed on the real scene the overlay scene displayed on the display screen and in a second position in which the user can view the display screen without viewing the real scene. For example, in the second position, the semitransparent mirror may lie against the body of the portable electronic device, and in the first position the semitransparent mirror may be pivoted away from the body of the portable electronic device. The user is thereby provided with a simple way of changing between an augmented reality viewing mode and a display-only viewing mode in which only the display screen is viewed.

Optionally pivotal rotation of the semitransparent mirror is motor driven. Also, optionally, adoption of the first mode is responsive to a first pivotal position of the semitransparent mirror and adoption of the second mode is responsive to a second pivotal position of the semitransparent mirror. The user is thereby provided with a simple way of changing between an augmented reality viewing mode and a display-only viewing mode, for example viewing call information on the display alone when making a call.

Optionally the display screen may also be pivotally mounted. Also, optionally pivotal rotation of the display screen may be motor driven.

Optionally, adoption of the first mode is responsive to a first pivotal position of the display screen and adoption of the second mode is responsive to a second pivotal position of the display screen.

In another embodiment of the portable electronic device, in the first mode the display screen is transparent and the real scene may be viewed through the display screen and in the second mode the real scene may not be viewed through the display screen. In such a second mode the view of the real scene may be obscured by electronic control of the display, or by mechanical means such as a masking device placed behind the display such that a non-overlay scene may be viewed on the display. The user is thereby provided with a simple way of changing between an augmented reality viewing mode and a display-only viewing mode in which only the display screen is viewed.

Optionally the portable electronic device comprises an orientation sensor and adoption of the first mode is responsive to a first orientation of the device and adoption of the second mode is responsive to a second orientation of the device.

In another embodiment of the invention the portable electronic device comprises storage means wherein the storage means contains a plurality of overlay scenes each corresponding to a different real scene and each comprising an alignment indicator corresponding to a predetermined element of their respective real scene, and selection means for selecting which of the plurality of overlay scenes is displayed, wherein the selection means is responsive to an indication of the location of the portable electronic device. By this means, the user is able to use the device for viewing any one of a plurality of augmented reality scenes, with the selection of the overlay scene being appropriate to the location of the device.

Optionally the portable electronic device comprises means to determine location and means to supply to the selection means the indication of location. By this means, selection of an appropriate overlay scene is automatic and need not require the user to provide an indication of location.

Optionally the portable electronic device comprises an orientation sensor and means to supply to the selection means an indication of orientation. By this means, an overlay scene appropriate to the orientation may be selected.

In another embodiment of the invention the portable electronic device comprises orientation sensing means for generating an indication of orientation, location determining means for generating an indication of location, and storage means wherein the storage means contains a plurality of overlay scenes each corresponding to a different real scene, and selection means for selecting which of the plurality of overlay scenes is displayed, wherein the selection means is responsive to the indications of location and orientation of the portable electronic device. Such overlay scenes may be displayed when an overlay scene aligns with the real scene sufficiently accurately not to require alignment of the overlay scene by the user.

In another embodiment of the invention the portable electronic device comprises means to receive over a radio link an overlay scene for display. By this means, overlay scenes do not need to be stored in the portable electronic device but can be supplied from a remote server over the radio link, or additional or updated overlay scenes can be transmitted from a remote server to a portable electronic device containing stored overlay scenes.

In another embodiment of the invention the portable electronic device comprises means to determine location and, optionally, an orientation sensor, and means to transmit an indication of location and, optionally, orientation over a radio link. By this means, a remote server receiving the indication of location and, optionally, orientation can select for transmission to the portable electronic device over the radio link an overlay scene appropriate to the location and, optionally, orientation of the portable electronic device.

According to another aspect of the invention there is provided an augmented reality system comprising a portable electronic device having means to receive over a radio link an overlay scene for display, serving means comprising storage means wherein the storage means contains a plurality of overlay scenes each corresponding to a different real scene and each comprising an alignment indicator corresponding to a predetermined element of their respective real scene and selection means for selecting one of the plurality of overlay scenes for display on the portable electronic device, wherein the selection means is responsive to an indication of the location and, optionally, orientation of the portable electronic device and the selected overlay scene is transmitted to the portable electronic device. In an embodiment of such a system, the indication of location and, optionally, orientation is transmitted to the serving means from the portable electronic device having a means to determine location and, optionally, an orientation sensor. Alternatively, location may be determined using means external to the portable electronic device.

According to another aspect of the invention there is provided an augmented reality system comprising a portable electronic device, wherein the portable electronic device comprises means to determine location and an orientation sensor, means to transmit an indication of location and orientation over a radio link, and means to receive over a radio link an overlay scene for display, the system further comprising serving means comprising storage means for storing a plurality of overlay scenes each corresponding to a different real scene, the serving means further comprising selection means for selecting one of the plurality of overlay scenes for display on the portable electronic device, wherein the selection means is responsive to the indications of the location and orientation of the portable electronic device, and means for transmitting the selected overlay scene to the portable electronic device.

The invention will be described, by way of example, with reference to the accompany drawings, wherein;

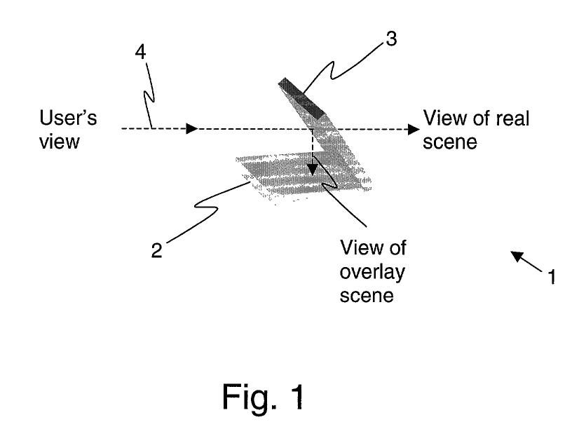

FIG. 1 illustrates a typical configuration of display screen and semitransparent mirror for viewing augmented reality,

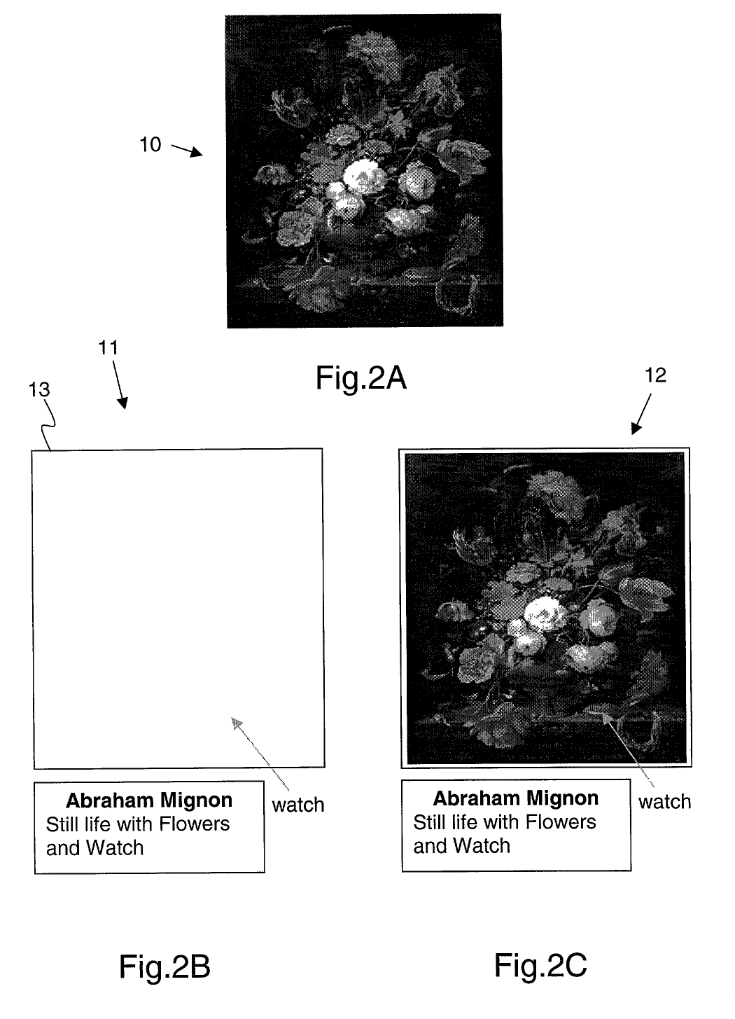

FIGS. 2A, 2B, and 2C show an example of the components of an augmented reality scene including an alignment indicator,

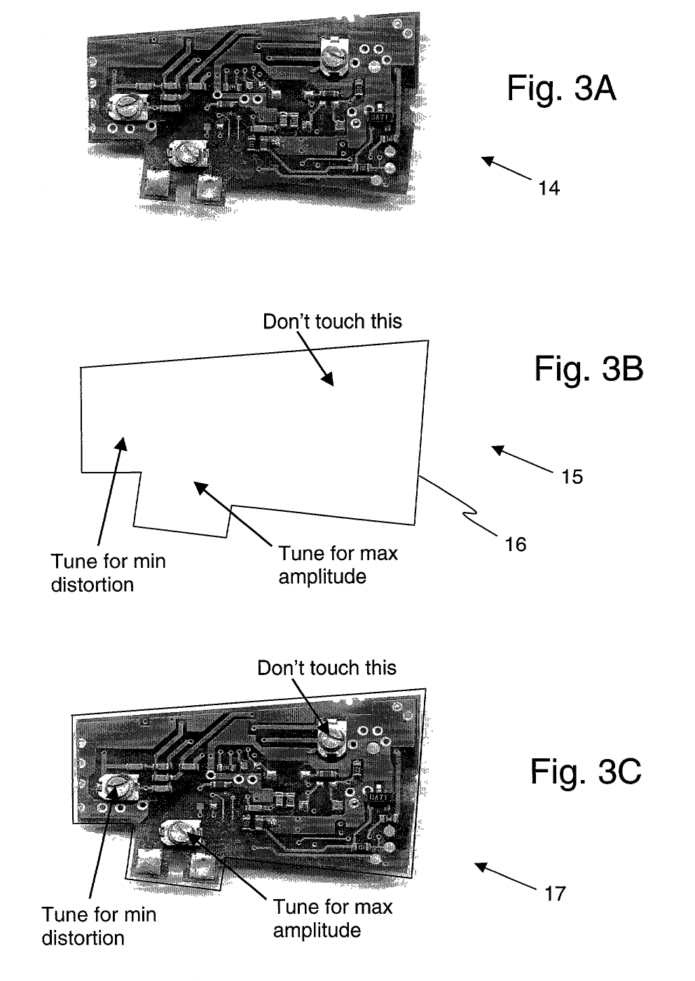

FIGS. 3A, 3B and 3C shows another example of the components of an augmented reality scene including an alignment indicator,

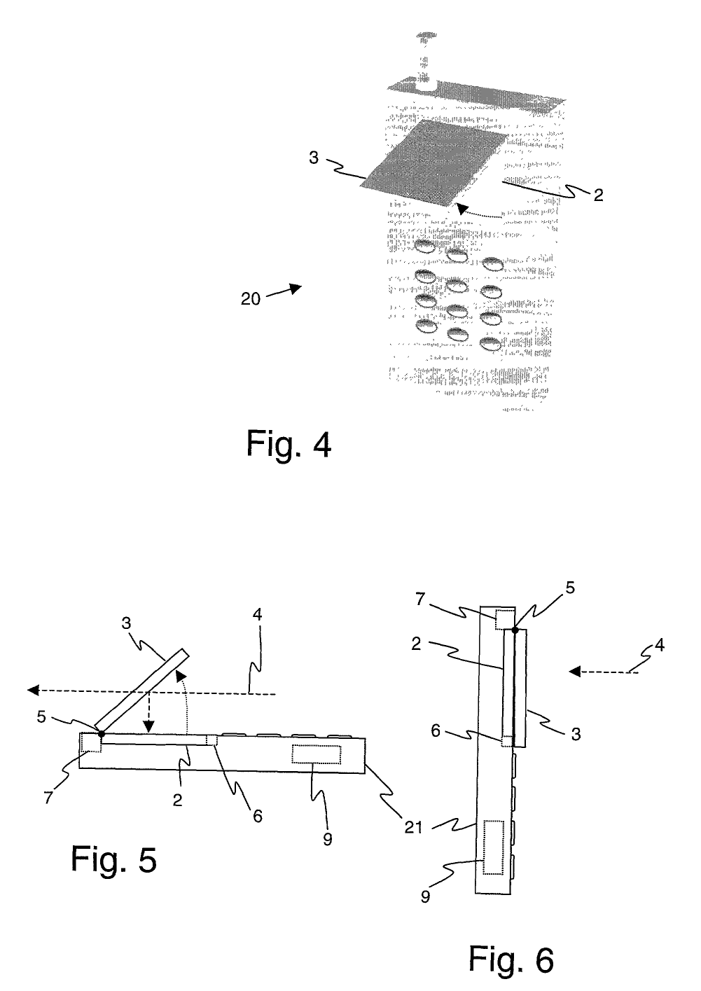

FIG. 4 is a schematic perspective view of a mobile phone equipped for viewing an augmented reality scene and having a pivotally mounted semitransparent mirror,

FIG. 5 is a schematic cross-sectional side view of the mobile phone shown in FIG. 4 with the semitransparent mirror arranged in a first position,

FIG. 6 is a schematic cross-sectional side view of the mobile phone shown in FIG. 3 with the semitransparent mirror arranged in a second position,

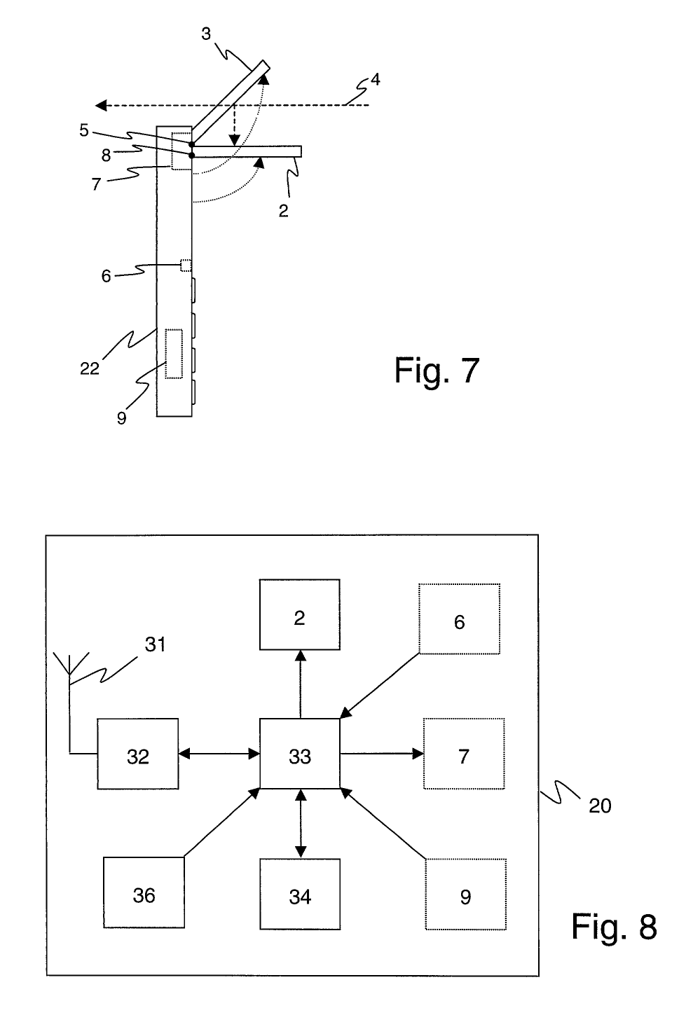

FIG. 7 is a schematic cross-sectional side view of a mobile phone equipped for viewing an augmented reality scene and having a semitransparent mirror and display screen both pivotally mounted,

FIG. 8 is a block schematic diagram of the primary electrical components of a mobile phone,

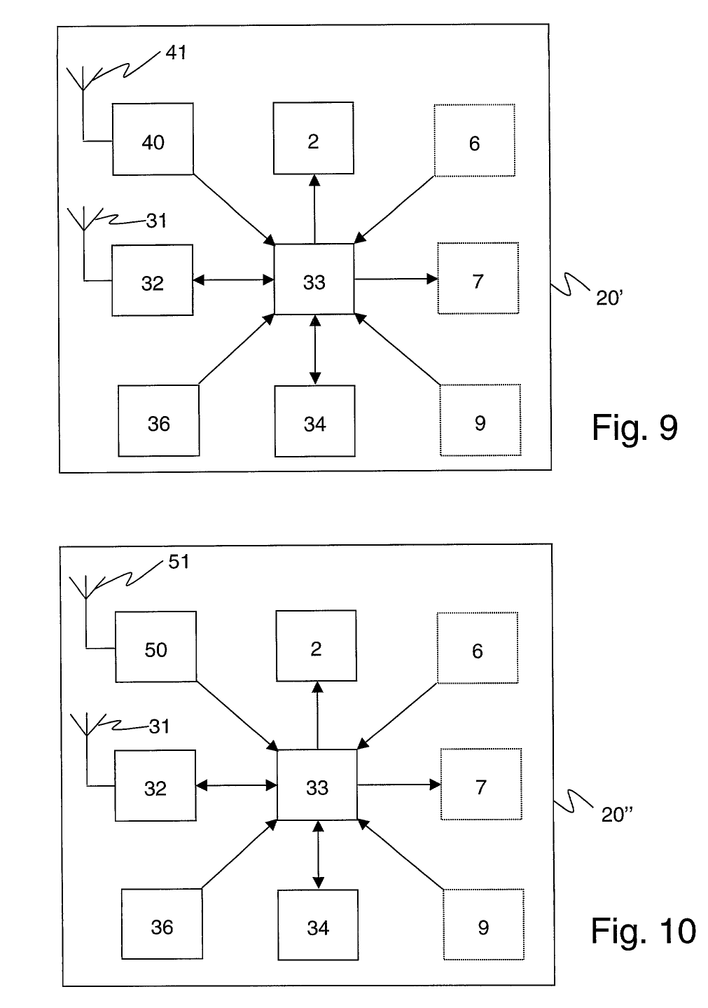

FIG. 9, is a block schematic diagram of a first embodiment of a location-sensitive mobile phone,

FIG. 10, is a block schematic diagram of a second embodiment of a location-sensitive mobile phone,

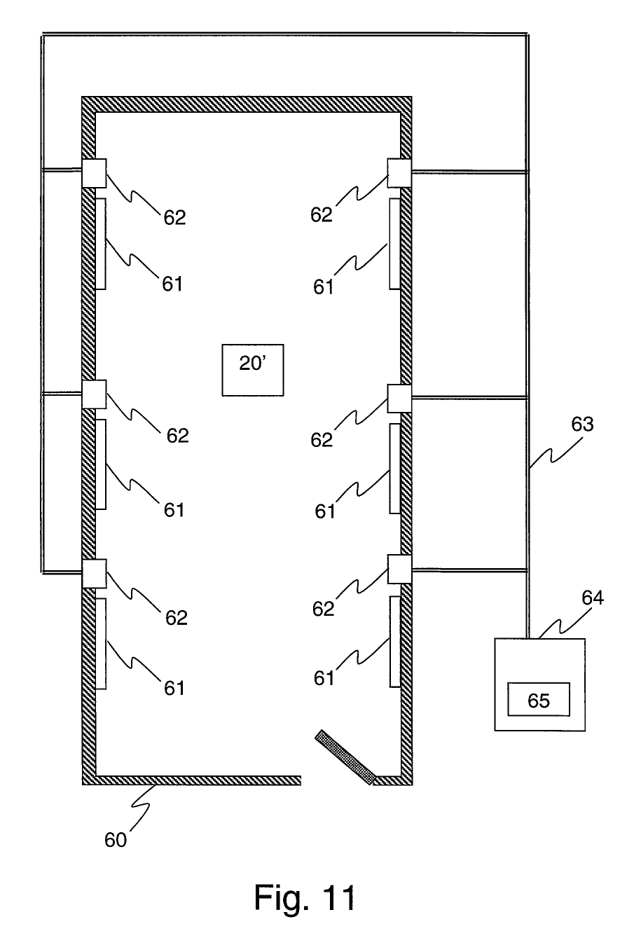

FIG. 11 illustrates a system using the first embodiment of a location-sensitive mobile phone,

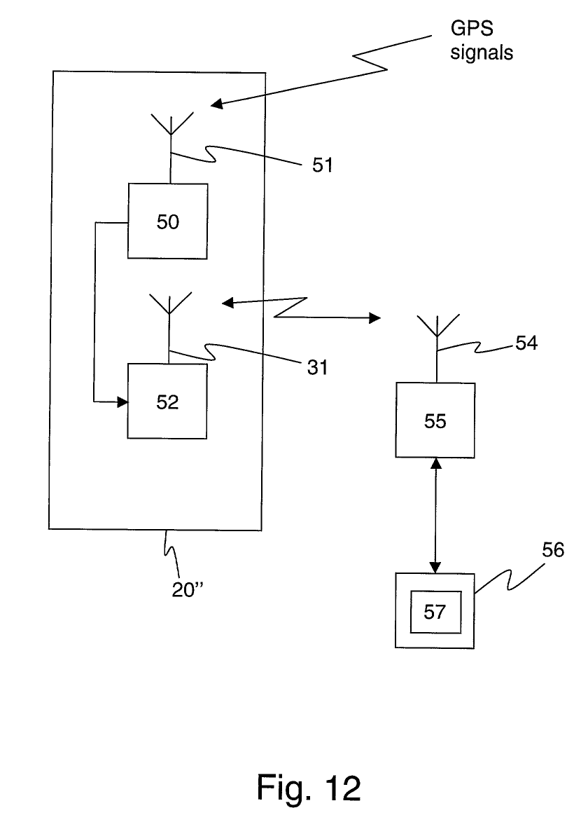

FIG. 12 illustrates a system using the second embodiment of a location-sensitive mobile phone,

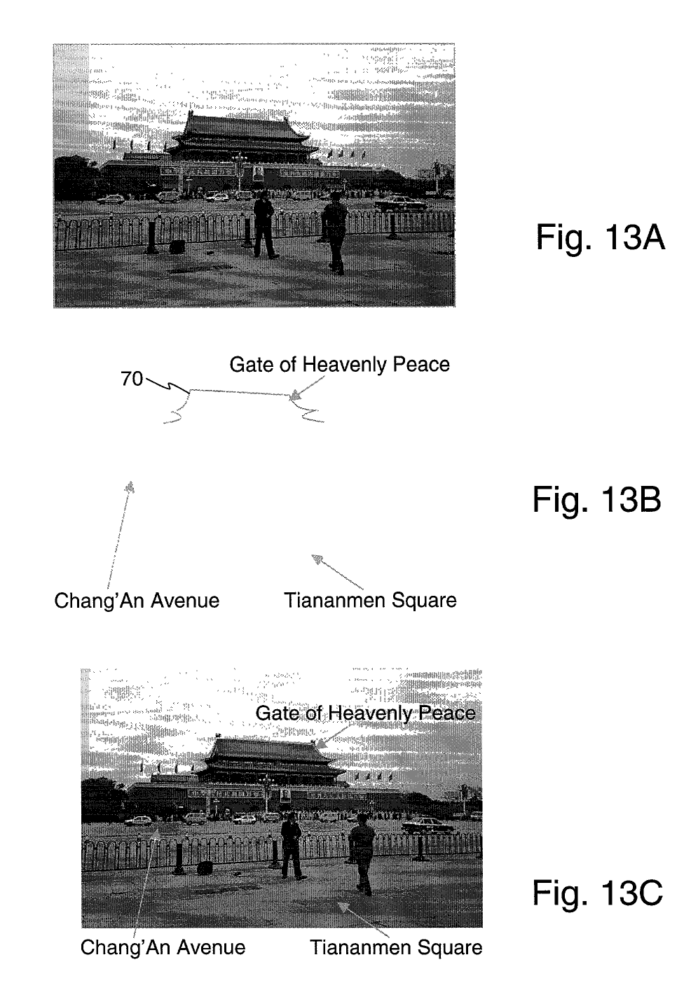

FIGS. 13A, 13B and 13C show an example of the components of an augmented reality scene including an alignment indicator displayed on a location-sensitive mobile phone in the system of FIG. 12, and

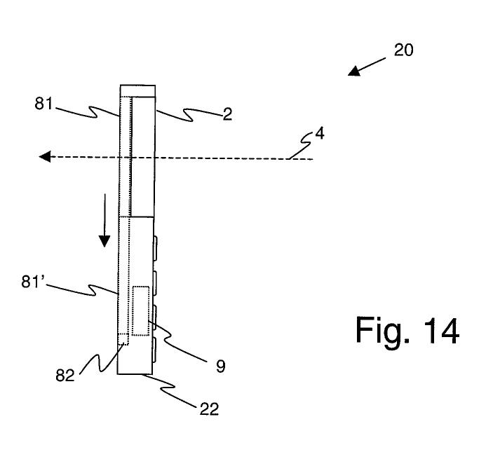

FIG. 14 is a schematic cross-sectional side view of a mobile phone with a transparent display.

First, the concept of an alignment indicator will be described. Then a portable electronic device suitable for viewing an augmented reality scene having an alignment indicator will be described, and then augmented reality systems using alignment indicators and such a portable electronic device will be described.

Referring to FIG. 1, there is illustrated a typical configuration of augmented reality viewing apparatus 1 comprising a display screen 2, such as an LCD screen, and a semitransparent mirror 3. The plane of the semitransparent mirror 3 is at approximately 45° to the plane of the display screen 2 and to the user's viewing direction 4. A user of the augmented reality viewing apparatus 1 views the semitransparent mirror 3 and sees a real scene through the semitransparent mirror 3, and sees a computer generated overlay scene which is displayed on the display screen 2 and reflected towards the user by the semitransparent mirror 3. In this way the real scene and the overlay scene are combined. For ease of reference, the term “semitransparent mirror” has been used throughout the specification and claims to encompass not only a semitransparent mirror but also any equivalent component.

In order that the user can align the overlay scene with the real scene the overlay scene includes one or more alignment indicators which correspond to predetermined elements of the real scene. Examples of such alignment indicators are illustrated in FIGS. 2B, 3B and 13B.

Referring to FIG. 2, in FIG. 2A there is a real scene 10 comprising a picture, for example as may be displayed in an art gallery. In FIG. 2B there is a computer generated overlay scene 11 which is displayed on the display screen 2. The overlay scene 11 includes an alignment indicator 13 which is provided to enable the user to align the real scene 10 with the overlay scene 11. The alignment indicator 13 corresponds to the perimeter of the picture. The remainder of the overlay scene 11 comprises annotation for the picture which includes information about a specific part of the picture (in this case pointing out a watch which may otherwise remain unnoticed by the user), the artist's name and the picture's title. FIG. 2C shows the composite view of the real scene 10 and the overlay scene 11, as seen by the user, when the user has aligned the displayed alignment indicator 13 with the corresponding element of the real scene 10 to form an augmented reality scene 12.

Referring to FIG. 3, in FIG. 3A there is a real scene 14 comprising an electronic circuit board, for example as may be seen by a service technician performing repair work, in FIG. 3B there is a computer generated overlay scene 15 which is displayed on the display screen 2. The overlay scene 15 includes an alignment indicator 16 which corresponds to the edge of the circuit board and which enables the user to align the real scene 14 with the overlay scene 15. The remainder of the overlay scene 15 comprises annotation which provides the user with information about specific parts of the electronic circuit board (in this case, for illustration only, pointing out where adjustments should be made). FIG. 3C shows the composite view 17 of the real scene 14 and the overlay scene 15, as seen by the user, when the user has aligned the displayed alignment indicator 16 with the corresponding elements of the real scene 14 to form an augmented reality scene 17.

Other examples of a real scene, overlay image and an alignment indicator that can be combined with the overlay image to create an overlay scene are presented in Table 1.

Portable electronic devices suitable for viewing an augmented reality scene having an alignment indicator will now be described using a mobile phoned as an example. Referring to FIG. 4, there is illustrated a schematic perspective view of a mobile phone 20 having a display screen 2 and a pivotally mounted semitransparent mirror 3 which can be positioned parallel to the display screen 2 when viewing only a displayed image and which can be rotated away from the display screen 2 as depicted in FIG. 4 when viewing an augmented reality scene. FIG. 5

TABLE 1

| Real Scene | Overlay image | Alignment indicator |
|---|---|---|
| City street | Annotation for shops of | A prominent building |
| | specific interest | |
| Landscape | Annotation for geological or | A prominent river, hill or |
| | historical features | building |
| Automobile | Servicing information | A prominent engine |
| engine | | component |
| Night sky | Names of stars | A prominent star, or |
| | | cross-wires |

illustrates schematically a cross-sectional side view of the mobile phone 20 of FIG. 4 when the pivotally mounted semitransparent mirror 3 is rotated about a pivot axis 5 to a position about 45° with respect to the display screen 2 so that the user can view an augmented reality scene. FIG. 5 also illustrates the user's line of vision 4 when viewing the augmented reality scene, the line of vision being parallel to the display surface of the display screen 2. The user moves the mobile phone 20 so that an image of a displayed alignment indicator reflected by the semitransparent mirror 3 is aligned with a predetermined element of the real scene being viewed through the semitransparent mirror 3. FIG. 6 illustrates schematically a cross-sectional side view of the mobile phone 20 of FIG. 4 when the pivotally mounted semitransparent mirror 3 is positioned parallel to the display screen 2 and also illustrates the user's line of vision 4 when viewing a displayed image alone without a real scene, the line of vision being approximately perpendicular to the display surface of the display screen 2.

Optionally the image displayed by the display screen 2 may be dependent on the angle of the semitransparent mirror 3 with respect to the body 21 of the mobile phone 20 or with respect to the display screen 2. In the embodiment illustrated in FIGS. 5 and 6, an optional switch means 6 detects whether the semitransparent mirror 3 is positioned parallel to the display screen 2 or is in a position pivoted away from the parallel position. If the switch means 6 detects that the semitransparent mirror 3 is positioned parallel to the display screen 2, only images that are intended to be viewed alone, without a real scene, are displayed on the display screen 2, such as call information when a call is being made. If the switch means 6 detects that the semitransparent mirror 3 is in a position pivoted away from the parallel position, an overlay scene for an augmented reality scene including an alignment indicator may be displayed on the display screen 2.

Optionally, the rotation of the semitransparent mirror 3 about the pivot axis 5 may be motor driven. In the embodiment illustrated in FIGS. 5 and 6, an optional motor 7 drives the rotation of the semitransparent mirror 3.

Optionally, the semitransparent mirror 3 and the display screen 2 may both be pivotally mounted. Referring to FIG. 7, there is illustrated schematically a cross-sectional side view of a mobile phone having a semitransparent mirror 3 which may be rotated about a first pivot axis 5 and a display screen 2 which may be rotated about a second pivot axis 8. In this embodiment, for viewing an augmented reality scene, the display screen 2 is rotated to approximately 90° with respect to a surface of the body 22 of the mobile phone, and the semitransparent mirror 3 is rotated to approximately 45° with respect to the display screen 2. The display screen 2 and the semitransparent mirror 3 are attached to the body 22 of the mobile phone such that, in these respective positions for viewing an augmented reality scene, the user's line of viewing 4 passes the body 22 and is not obstructed by the body 22. The user moves the mobile phone so that an image of a displayed alignment indicator reflect by the semitransparent mirror 3 is aligned with a predetermined element of the real scene being viewed through the semitransparent mirror 3.

Optionally the image displayed by the display screen 2 of the mobile phone illustrated in FIG. 7 may be dependent on the angle of the semitransparent mirror 3 or the display screen 2 with respect to the body 22 of the mobile phone. In the embodiment illustrated in FIG. 7, an optional switch means 6 detects whether the display screen 2 is in a position rotated away from the body 22. If the switch means 6 detects that the display screen 2 is not rotated away from the body 22, only images intended to be viewed alone, without a real scene, are displayed on the display screen 2, such as call information when a call is being made. If the switch means 6 detects that the display screen 2 is in a position rotated away from the body 22, an overlay scene for an augmented reality scene including an alignment indicator may be displayed on the display screen 2. Alternatively or additionally (not illustrated), a sensor or switch means may be incorporated to detect whether or not the semitransparent mirror 3 is positioned parallel to the display screen 2, and a non-overlay image or an overlay scene for an augmented reality scene is displayed appropriately.

Optionally, the rotation of the display screen 2 and the semitransparent mirror 3 about the pivot axes 8 and 5 respectively may be motor driven. In the embodiment illustrated in FIG. 7, an optional motor 7 drives the rotation of the display screen 2 and the semitransparent mirror 3.

A further embodiment of a portable electronic device suitable for viewing an augment reality scene having an alignment indicator will now be described. Referring to FIG. 14, there is illustrated a schematic cross-sectional side view of a mobile phone 20 having a fixed display screen 2. FIG. 14 also illustrates the user's line of vision 4 when viewing the augmented reality scene, the line of vision being perpendicular to the display surface of the display screen 2. In this embodiment the display screen 2 is transparent when the augmented reality scene is being viewed, except that elements of the overlay scene need not be transparent, such that the real scene may be view through the display screen 2. Such a transparent display screen 2 may use known technology. When a non-overlay scene is to be viewed the real scene is obscured. The obscuration may be achieved in a variety of ways, for example the display screen 2 may be altered electrically to make it non-transparent or semitransparent, or a mechanical means may be used to obscure the real scene. In FIG. 14 an optional masking device 81 is mounted behind the display screen 2 and obscures the real scene when in the position shown at 81, and may be slide away from the display screen 2 into the position shown at 81′ to enable a real scene to be viewed through the transparent display screen 2. Optionally, switch means 82 may be provided to detect whether or not the masking device 81 is in position to obscure the real scene. If the real scene is obscured, only non-overlay images intended to be viewed alone without a real scene are displayed on the display screen 2, such as call information when a call is being made. If the switch means 82 detects that the real scene is not obscured by the masking device 81 (in position shown at 81′ ) an overlay scene for an augmented reality scene including an alignment indicator may be displayed on the display screen 2.

As will be apparent from the orientation of the mobile phone and the user's line of vision in FIGS. 5, 6 and 14, the user may wish to hold the mobile phone in different orientations according to whether an augmented reality scene is being viewed, as illustrated in FIGS. 5 and 14, or a non-overlay image is being viewed, as illustrated in FIG. 6. A further option is the inclusion of an orientation sensor 9 which detects the orientation of the mobile phone 20 and thereby controls whether a non-overlay image is displayed on the display screen 2 or an overlay scene for an augmented reality scene is displayed.

Referring to FIG. 8, there is shown a block schematic diagram of the primary electrical components of a mobile phone 20. A radio antenna 31 is coupled to a transceiver 32. The transceiver 32 supports radio operation on a cellular phone network. The transceiver is coupled to a processing means 33. The transceiver delivers received data to the processing means 33, and the processing means 33 delivers data to the transceiver for transmission. The processing means 33 is coupled to a display screen 2 to which it delivers images for display, to an optional orientation sensor 9 which delivers to the processing means 33 an indication of the orientation of the mobile phone 20, to a memory means 34 which stores images for display on the display screen 2, and to a user input means 36 such as a keypad by which means the user may issue commands to the processing means 33. In the case of an embodiment having the pivotally mounted semitransparent mirror 3, the processing means 33 is also coupled to an optional motor 7 which under the control of the processor means 33 rotates the semitransparent mirror 3 between a position parallel to the display screen 2 and a position at approximately 45° to the display screen. The processing means 33 is also coupled to an optional switch means 6 which, in the case of an embodiment having the pivotally mounted semitransparent mirror 3, delivers to the processing means 33 an indication of whether the pivotally mounted semitransparent mirror 3 is positioned parallel to, or rotated away from, the display screen 2, and in the case of an embodiment having a transparent display screen 2 and a masking device 81, delivers to the processing means 33 an indication of whether the masking device 81 is obscuring the real scene.

The memory means 34 contains one or more overlay scenes for display, corresponding to one or more real scenes. The overlay scenes may be pre-stored in the memory means 34, and/or may be transmitted by radio to the mobile phone 20 from a remote server, being received by the transceiver 32 and stored in the memory means 34 by the processing means 33.

The choice of whether an overlay scene or a non-overlay image is displayed on the display screen 2 is determined either by a user command issued to the processing means 33, or by the rotational position of the semitransparent mirror 3 (if present) as described above, or by the rotational position of the display screen 2 (if pivotally mounted), or by the position of the blanking device 81 (if present) as described above, or by an indication from the orientation sensor 9 as described above, or by a signal received by means of the transceiver 32.

The selection of one of a plurality of overlay scenes for display is made by user command issued to the processing means 33. In this way, the user may select an overlay scene to match his location and the real scene he wishes to view. Alternatively, the selection of an overlay scene for display to match the location and the real scene is determined by location determining apparatus associated with the mobile phone 20.

In another embodiment, the selection of one of a plurality of overlay scenes for display is responsive to an indication of location and, optionally, an indication of orientation of the mobile phone 20. In this embodiment the indication of orientation may be generated by the illustrated orientation sensor 9 or by a second orientation sensor.

In other embodiments to be described below, the selection of an overlay scene for display to match the location and the real scene, and, optionally, to suit the orientation, is determined remotely from the mobile phone and user. Two such location-sensitive embodiments will be described.

Referring to FIG. 9, there is illustrated a first location-sensitive embodiment of a mobile phone 20′. The elements of the embodiment in FIG. 9 that are the same as the embodiment in FIG. 8 will not be described again. The embodiment in FIG. 9 differs from the embodiment in FIG. 8 by having a secondary antenna 41 and a secondary transceiver 40. The secondary transceiver 40 supports short range communication, for example, complying with the Bluetooth radio standard. The mobile phone 20′ receives from a remote short range transceiver an overlay scene for display or a command to display a specific one of a plurality of overlay scenes stored in the memory means 34.

An example of a system in which the embodiment of FIG. 9 can be used is illustrated in FIG. 11. Referring to FIG. 11 there is illustrated a plan of a room in an art gallery. The room houses paintings 61. Positioned adjacent to each painting is a short range radio transceiver 62. The short range transceivers are connected via a local area network (LAN) 63 to a server 64. The mobile phone 20′ is carried by a visitor to the art gallery. As the visitor moves close to each picture 61 in turn, the nearby short range radio transceiver 62 is able to communicate with the secondary transceiver 40 of the mobile phone 20′, thereby recognising the presence of the mobile phone 20′. Having recognised the presence of the mobile phone 20′, the short range radio transceiver 62 reports to the server 64 the presence of the mobile phone 20′ via the LAN 63. The server 64 deduces the location of the mobile phone 20′ by recognising which short range radio transceiver 62 reported the presence of the mobile phone 20′, selects from a storage memory 65 containing an overlay scene for each picture in the room an overlay scene corresponding to the picture adjacent to the reporting short range transceiver 62, and forwards that overlay scene to the short range transceiver 62 for transmission to the mobile phone 20′.

Each stored overlay scene includes an alignment indicator corresponding to a predetermined feature of the adjacent picture. The alignment indicator may correspond to, for example, the edge of the picture. The overlay scene is received by the secondary transceiver 40 and is displayed on the display screen of the mobile phone 20′. In this way, the mobile phone 20′ displays a scene that is dependent on the location of the mobile 20′. As the visitor moves to view each painting, the short range transceiver nearest each picture transmits an overlay scene that is appropriate to the nearest picture.

The visitor positions the mobile phone 20′ to align the alignment indicator of the displayed overlay scene with his view of the nearby picture. The overlay scene may include, for example, annotations such as a commentary on the picture and highlighting of features of specific interest in the picture. An example of such annotations is included in FIG. 2B.

Referring now to FIG. 10, there is illustrated a second location-sensitive embodiment of a mobile phone 20″. The elements of the embodiment in FIG. 10 that are the same as the embodiment in FIG. 8 will not be described again. The embodiment in FIG. 10 differs from the embodiment in FIG. 8 by having a secondary antenna 51 and a Global Positioning System (GPS) receiver 50. The GPS receiver 50 evaluates the position of the mobile phone 20″ and reports the location to the processing means 33. An indication of orientation generated by the optional orientation sensor 9 may also be reported to the processing means 33.

An example of a system in which the embodiment of FIG. 10 can be used is illustrated in FIG. 12. Referring to FIG. 12 there is illustrated the mobile phone 20″ having the embodiment illustrated in FIG. 10. For simplicity in FIG. 12, the elements of the mobile phone 20″ are grouped together in block 52, except for the antenna 31, the GPS receiver 50, and the secondary antenna 51. The mobile phone 20″ communicates with a server 56 via a cellular phone network which is represented in FIG. 12 by an antenna 54 and block 55.

The mobile phone 20″ reports its location and, optionally, orientation to the remote server 56. The server 56 selects from a storage memory 57 containing a plurality of overlay scenes the scene most closely matching the user's location and, optionally, orientation. The selected overlay scene may optionally be transformed by being re-sized or zoomed (in or out) to improve the match between the overlay scene and the user's view of the real scene. The selected and transformed overlay scene is transmitted to the mobile 20″.

Each stored overlay scene includes an alignment indicator corresponding to a predetermined feature of a real scene at the location of the mobile phone 20″. The overlay scene is received by the secondary transceiver 40 and is displayed on the display screen of the mobile phone 20″. In this way, the mobile phone 20″ displays a scene that is dependent on the location and, optionally, orientation of the mobile 20″. The user positions the mobile phone 20″ to align the alignment indicator of the displayed overlay scene with his view of the corresponding predetermined element of the real scene. An example of such a scene is shown in FIGS. 13A, 13B and 13C. FIG. 13A is a cityscape real scene and FIG. 13B is an overlay scene in which the alignment indicator 70 corresponds to a distinctive rooftop and the remainder of FIG. 13B comprises annotation of place names of interest to a tourist. FIG. 13C shows the augmented reality scene comprising the real scene of FIG. 13A and the overlay scene of FIG. 13B.

In some applications, an overlay scene need not include an alignment indicator if the indications of location and orientation are sufficiently accurate to enable selection of a suitable overlay scene without any need for the user to align the mobile phone.

From reading the present disclosure, other modifications will be apparent to persons skilled in the art. Such modifications may involve other features which are already known in the art of augmented reality, portable electronic devices and mobile phones which may be used instead of or in addition to features already described herein.

1. A method of preparing an overlay scene for display on an augmented reality viewing apparatus, characterised by generating an alignment indicator corresponding to a predetermined element of a real scene for inclusion in the overlay scene, the alignment indicator in use being aligned with the predetermined element of the real scene.

2. An overlay scene suitable for combining with a real scene to form an augmented reality scene, comprising an alignment indicator corresponding to a predetermined element of the real scene, the alignment indicator in use being aligned with the predetermined element of the real scene.

3. A portable electronic device equipped with augmented reality viewing apparatus suitable for viewing a real scene and an overlay scene having an alignment indicator corresponding to a predetermined element of the real scene, the augmented reality viewing apparatus comprising a display screen, wherein the device has a first mode wherein the display screen displays an overlay scene and a second mode wherein the display screen displays a non-overlay scene.

4. A device as claimed in claim 3, wherein the viewing apparatus further comprises a pivotally mounted semitransparent mirror arrangeable in a first position in which a user can view superimposed on the real scene an overlay scene displayed on the display screen and in a second position in which the user can view the display screen without viewing the real scene.

5. A device as claimed in claim 4, wherein pivotal rotation of the semitransparent mirror is motor driven.

6. A device as claimed in claim 4, wherein the display screen is pivotally mounted.

7. A device as claimed in claim 6, wherein pivotal rotation of the display screen is motor driven.

8. A device as claimed in claim 4, wherein adoption of the first mode is responsive to a first pivotal position of the semitransparent mirror and adoption of the second mode is responsive to a second pivotal position of the semitransparent mirror.

9. A device as claimed in claim 6, wherein adoption of the first mode is responsive to a first pivotal position of the display screen and adoption of the second mode is responsive to a second pivotal position of the display screen.

10. A device as claimed in claim 3, wherein in the first mode the display screen is transparent and the real scene may be viewed through the display screen and in the second mode the real scene may not be viewed through the display screen.

11. A device as claimed in any one of claims 3 to 10, comprising storage means wherein the storage means contains a plurality of overlay scenes each corresponding to a different real scene and each comprising an alignment indicator corresponding to a predetermined element of their respective real scene, and selection means for selecting which of the plurality of overlay scenes is displayed, wherein the selection means is responsive to an indication of the location of the portable electronic device.

12. A device as claimed in claim 11, comprising means to determine location and means to supply to the selection means the indication of location.

13. A device as claimed in claim 12, comprising an orientation sensor and means to supply to the selection means an indication of orientation, wherein the selection means is responsive to the indication of orientation.

14. A device as claimed in any one of claims 3 to 10, comprising orientation sensing means for generating an indication of orientation, location determining means for generating an indication of location, and storage means wherein the storage means contains a plurality of overlay scenes each corresponding to a different real scene, and selection means for selecting which of the plurality of overlay scenes is displayed, wherein the selection means is responsive to the indications of location and orientation of the portable electronic device.

15. A device as claimed in any one of claims 3 to 10, further comprising means to receive over a radio link an overlay scene for display.

16. A device as claimed in claim 15, further comprising means to determine location and means to transmit an indication of location over a radio link.

17. A device as claimed in claim 16, further comprising an orientation sensor and means to transmit an indication of orientation over a radio link.

18. A device as claimed in claim 3, comprising an orientation sensor, wherein adoption of the first mode is responsive to a first orientation of the device and adoption of the second mode is responsive to a second orientation of the device.

19. An augmented reality system comprising a portable electronic device as claimed in claim 15, serving means comprising storage means for storing a plurality of overlay scenes each corresponding to a different real scene and each overlay scene comprising an alignment indicator corresponding to a predetermined element of its respective real scene, the serving means further comprising selection means for selecting one of the plurality of overlay scenes for display on the portable electronic device, wherein the selection means is responsive to an indication of the location of the portable electronic device, and means for transmitting the selected overlay scene to the portable electronic device.

20. An augmented reality system as claimed in claim 19, the portable electronic device further comprising means to determine location and means to transmit an indication of location over a radio link to the serving means.

21. An augmented reality system as claimed in claim 20, the portable electronic device further comprising an orientation sensor and means to transmit an indication of orientation over the radio link to the serving means, and wherein the selection means is responsive to the indication of orientation of the portable electronic device.

22. An augmented reality system comprising a portable electronic device as claimed in claim 17, serving means comprising storage means for storing a plurality of overlay scenes each corresponding to a different real scene, the serving means further comprising selection means for selecting one of the plurality of overlay scenes for display on the portable electronic device, wherein the selection means is responsive to the indications of the location and orientation of the portable electronic device, and means for transmitting the selected overlay scene to the portable electronic device.
